(19) United States
(12) Patent Application Publication
(10) Pub. No.: US 2007/0285231 A1
(43) Pub. Date: Dec. 13, 2007

(54) Security device for textile products

(75) Inventors: Steven Andrew Leftly, Embsay (GB); Dianne C. Jones, Embsay (GB)

Correspondence Address: BROMBERG & SUNSTEIN LLP, 125 SUMMER STREET, BOSTON, MA, 02110-1618, US

(73) Assignee: Sentrix Technology Limited, Central Hong Kong (HK)

(21) Appl. No.: 11/728,955

(22) Filed: Mar. 27, 2007

(30) Foreign Application Priority Data
Mar. 27, 2006 (GB) 0606005.7

(51) Int. Cl. G08B 21/00

(52) U.S. Cl. 340/540

(57) ABSTRACT

A security device for use with a textile article is used to detect an open or closed state of a pocket or other enclosure in the article and to provide a warning to the user/wearer of the article. When a moveable closure of the article is moved from a closed configuration to an open configuration (or vice-versa, as the case may be) an electrical circuit is broken (or made) which is detected by an electronic processor. An alarm, such as an audible or visual indication, is then given electronically by the processor in response to the change in configuration.

This application claims priority to UK application serial no. GB 0606005.7, filed Mar. 27, 2006 by Steven Leftly and Dianne Jones, entitled “Security Device for Textile Products,” which is hereby incorporated by reference in its entirety.

The present invention relates to the design of an alarmed security system suitable for use in textile products. The alarm system described herein is able to detect the open or closed state of a textile bag or pocket or other enclosure within the product.

As people are carrying more valuable personal possessions in garment pockets, bags, luggage and other carrying accessories it is more important to protect these items from casual theft or pickpockets. It is therefore desirable to have an enclosure on a bag or garment that is armed with a security device that alerts the user to unauthorised access to that enclosure. This invention relates to an alarm system that is suitable for use in a broad range of garment pockets, bags, luggage and other carrying accessories. Due to the soft and flexible nature of these products, ideally the alarm system has small, flexible and unobtrusive components so as not to interfere with the comfort or functionality of the product. The alarm system must also be suitable for integration into these products using conventional manufacturing methods found in the garment and soft-goods manufacturing industries.

Embodiments of this invention aim to allow for production in large volumes and with an economical system.

In accordance with one aspect of the present invention there is provided a security apparatus for a substantially manmade or natural textile, leather or fabric article comprising a closure moveable between an open and closed configuration, the apparatus comprising:

at least one electrically conductive element located on or in the article;

a source of electrical power; and

an electrically operated alarm;

wherein the alarm is arranged to be activated when the closure moves from one of the open and closed configurations to the other configuration.

Preferably the apparatus further includes circuit making/breaking apparatus or a bridging component arranged such that when the closure moves from one of the open and closed configurations to the other configuration the bridging component moves, causing an electrical circuit to be made or broken.

The electrically conductive element is preferably a flexible electrical conductor, and may be a textile structure.

The apparatus may further include an electronic controller comprising a processor arranged to control the alarm in response to movement of the closure from one of the open and closed configurations to the other configuration.

The alarm may comprise a visual or audible alarm or some other indicator, such as a vibrating element.

The apparatus is preferably arranged such that in the closed configuration the closure is arranged to make physical and electrical connection with a portion of the article.

The physical and/or the electrical connection is preferably made through one or more connector elements.

The or each connector element may comprise one or more of: snap fasteners, rivets, conductive hook and eye contacts such as conductive Velcro®, magnetic strips or components or other textile fixtures.

According to a second aspect of the invention there is provided a substantially man-made or natural textile, leather or fabric article comprising a closure moveable between an open and closed configuration including a security apparatus according to any statement herein.

In one preferred arrangement the circuit making/breaking apparatus comprises a magnet and reed switch, one of which is located on the closure and the other of which is located on a portion of the article.

The present invention is defined in the attached independent claim, to which reference should now be made. Further preferred features may be found in the sub-claims appended thereto.

The present invention may include any combination of the features or limitations referred to herein, except a combination of such features as are mutually exclusive.

Embodiments of the present invention will now be described, by way of example only, with reference to the accompanying drawings, in which:

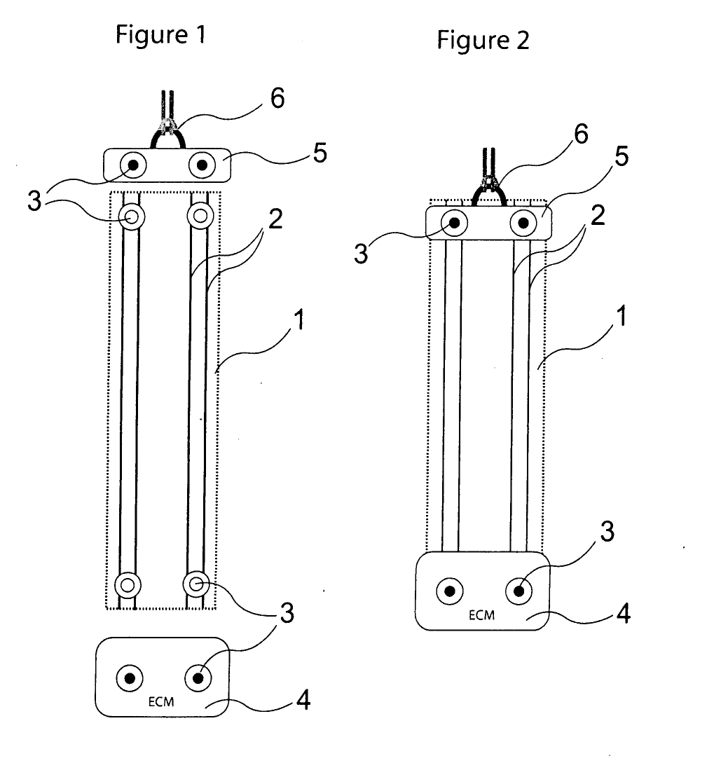

FIG. 1 shows schematically in plan view an embodiment of the invention in a first configuration;

FIG. 2 shows the embodiment of FIG. 1 in a second configuration;

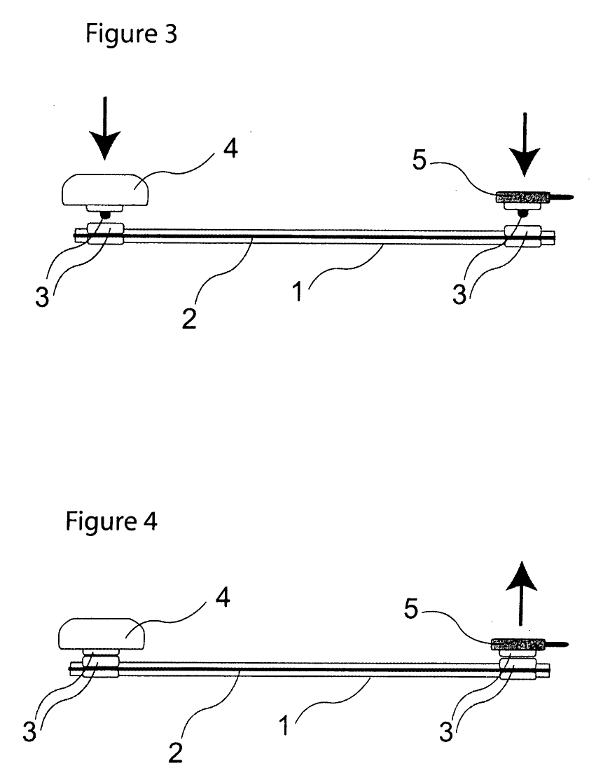

FIG. 3 is a schematic side view of the embodiment of FIGS. 1 and 2 in a first configuration;

FIG. 4 is a schematic side view of the embodiment of FIGS. 1 and 2 in a second configuration;

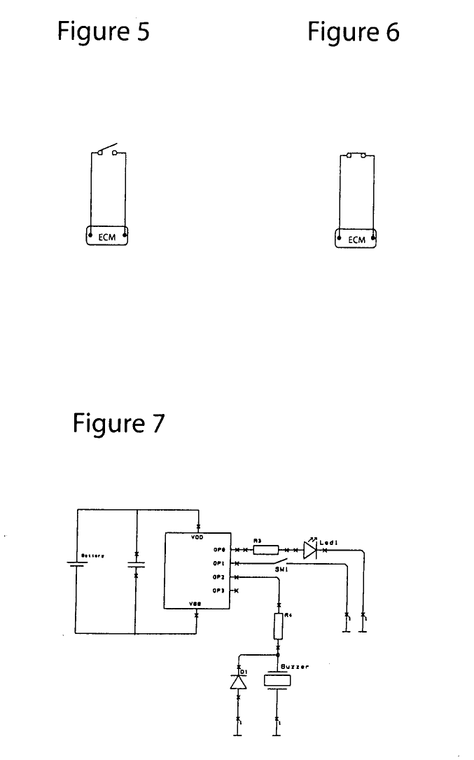

FIG. 5 is a schematic circuit diagram of the embodiment of FIGS. 1 and 2 in a first configuration;

FIG. 6 is a schematic circuit diagram of the embodiment of FIGS. 1 and 2 in a second configuration;

FIG. 7 is a schematic circuit diagram of an alarm control circuit;

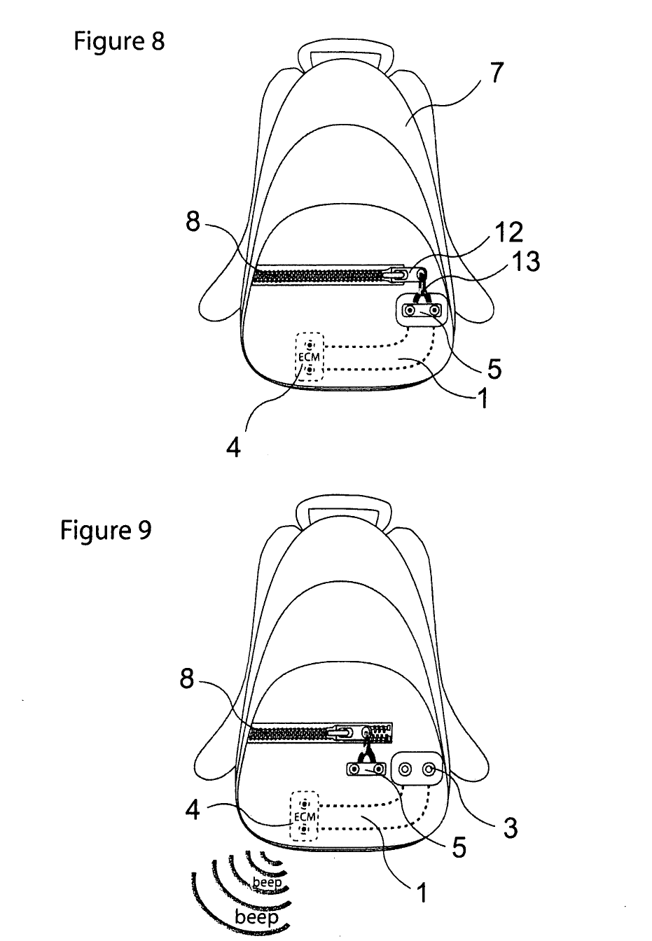

FIG. 8 is a schematic diagram of a further embodiment of the invention in a first configuration;

FIG. 9 is a schematic diagram of the embodiment of FIG. 8 in a second configuration;

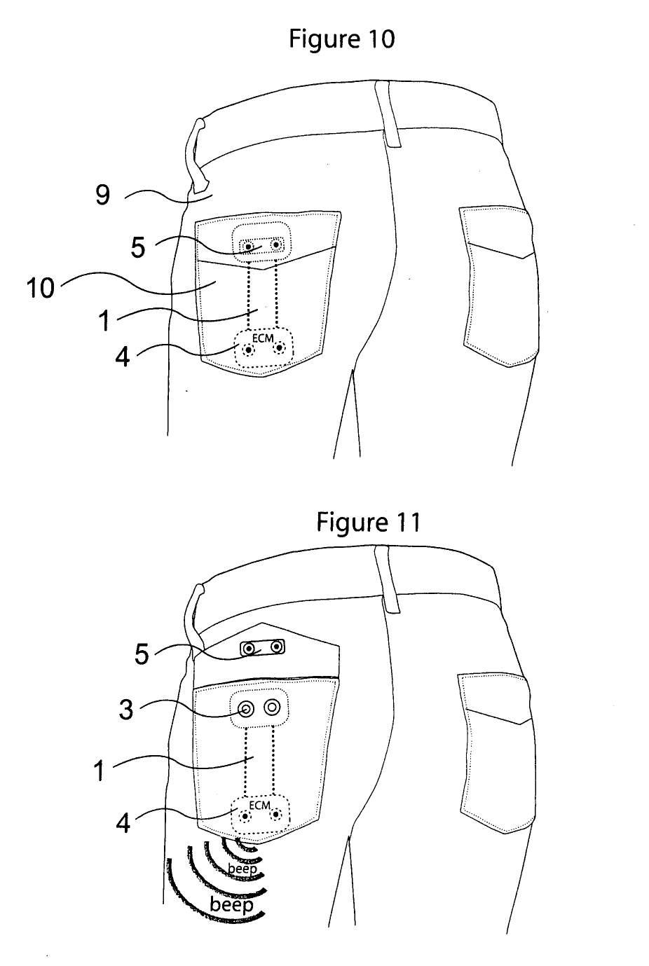

FIG. 10 is a schematic diagram of a further embodiment of the invention in a first configuration;

FIG. 11 is a schematic diagram of the embodiment of FIG. 10 in a second configuration;

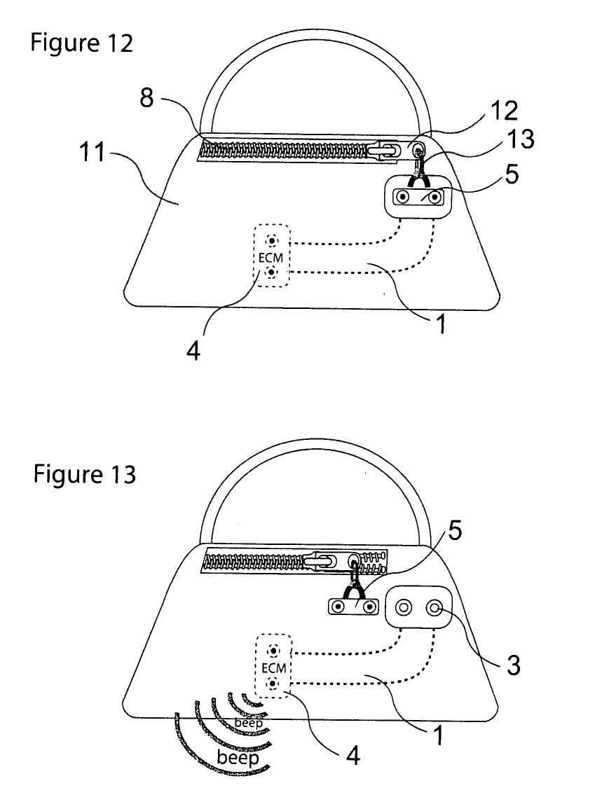

FIG. 12 is a schematic diagram of a further embodiment of the present invention in a first configuration;

FIG. 13 is a schematic diagram of the embodiment of FIG. 12 in a second configuration;

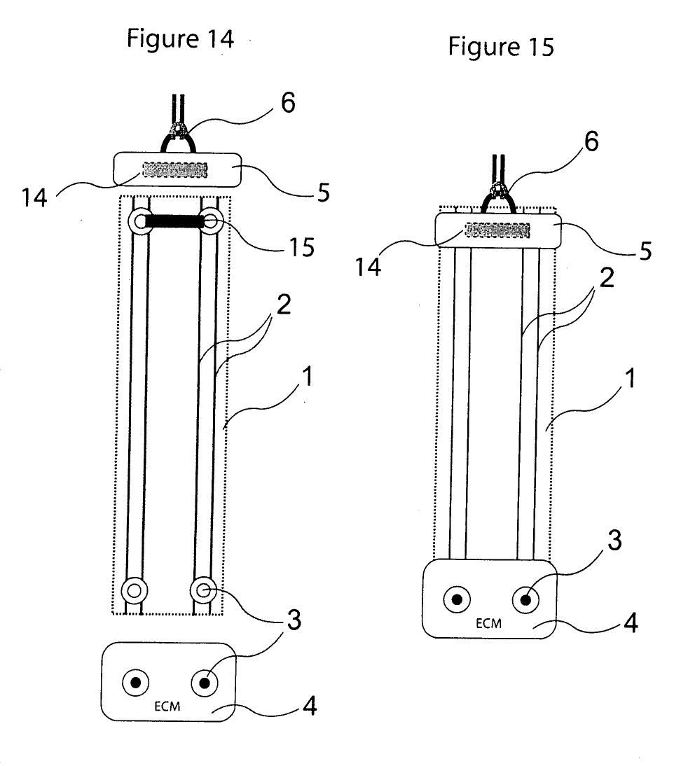

FIG. 14 is a schematic diagram of a further embodiment of the present invention in a first configuration;

FIG. 15 is a schematic diagram of the embodiment of FIG. 14 in a second configuration;

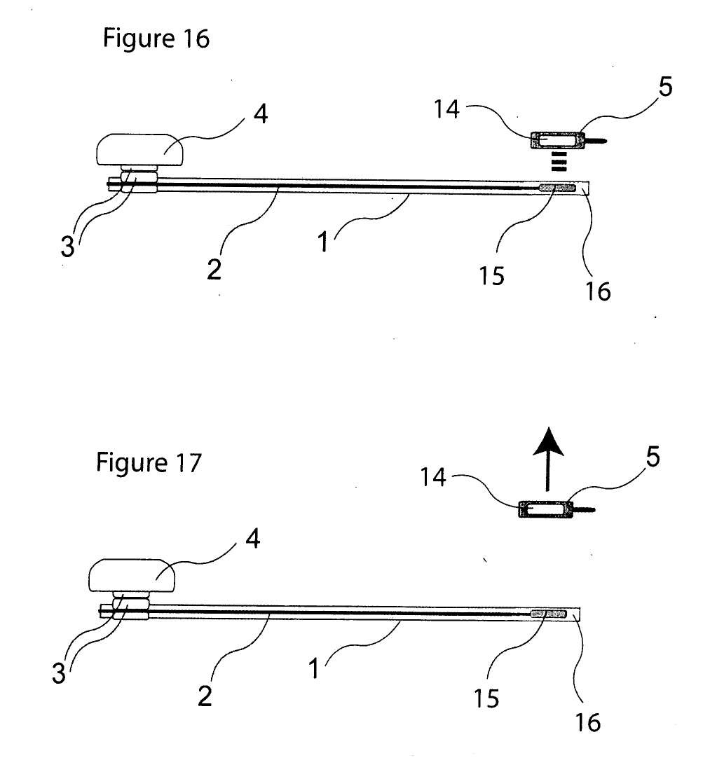

FIG. 16 is a side schematic view of the embodiment of FIGS. 14 and 15 in a first configuration; and

FIG. 17 is a side schematic view of the embodiment of FIGS. 14 and 15 in a second configuration.

In addition to an electrical power supply, such as a battery, embodiments of the security device according to the invention comprise three main components as follows:

1. A ‘flexible signal carrier’ is a flexible structure containing at least two parallel flexible electrical conductors or ‘electrodes’. The flexible signal carrier is preferably a textile structure and the electrodes are highly flexible conductive yarns or wires integrated within the textile structure. The electrodes are generally shielded within the flexible signal carrier but become exposed at specific designated positions referred to as ‘contact points’ along the flexible signal carrier. These contact points are used for the attachment of ‘connector elements’.

For example, the flexible signal carrier may be constructed from one or more of the following:
a textile fabric containing metallic fibre conductors, woven, knitted, braided or laid in the structure;
a textile fabric containing wires woven, knitted or laid in the structure;
a flexible film or fabric with printed or coated electrically conductive tracks;
a flexible flat cable (FFC) containing metallic foil strips laminated with polymer shielding in a flat strip film;
a soft shielded wire cable; or
any combination of the above.

The flexible signal carrier may contain a plurality of electrodes within the above structure. The electrodes may be used in pairs or singularly to create the alarm circuit. The electrodes may be aligned to correspond with an industry standard termination method and are usually spaced for example 2.54 mm or 1.25 mm apart.

The flexible signal carrier may also be encapsulated in a polymer material using compression, injection or other moulding techniques to create a flexible contained device that may also be waterproof or resistant to moisture or chemicals or other harsh environments.

The contact points of the flexible signal carrier can be constructed using, for example, any of the following methods:
a metallic contact component that is attached to the electrode at specific locations using a tool (such as a crimp termination component e.g. Nicomatic Crimplex crimp contacts);
where the electrode is composed of a metallic wire or yarn (such as Du Pont—Aracon® or Silver coated nylon yarn) shielded within the flexible signal carrier, a contact point is formed where the wire or yarn is raised to the surface of the flexible signal carrier to allow for electrical contact;
an electrically conductive material printed or coated on the flexible signal carrier.

2. A ‘bridging component’ is a structure that is attached to one end of the flexible signal carrier so as to provide an electrical pathway between the electrodes within the flexible signal carrier. The bridging component is preferably a device easily attached and detached from the flexible signal carrier by way of ‘connector elements’ that are preferably permanently fixed to the bridging component.

The bridging component may also be reed switch and magnet component, in which case physical contact is not required to open or close the circuit.

The connector elements in the bridging component can be for example:
snap fasteners, rivets or other textile fixtures;
conductive Velcro®;
magnetic strips or components;
a reed switch;
or a combination of the above.

The connector elements maybe fixed to the bridging component using the following methods, for example:
two snap fasteners or rivets electrically connected within a woven or braided fabric;
two snap fasteners or rivets electrically connected within a metal structure;
two snap fasteners or rivets electrically connected within a conductive rubber structure;
two magnetic fixtures or snap fasteners within a metallic structure;
two snap fasteners or rivets electrically connected within a moulded plastic or rubber structure;
two magnetic fixtures or snap fasteners within a moulded plastic or rubber structure;
soldering onto a soft wire cable.

The bridging component can be connected to the flexible signal carrier using mating connector elements which are preferably permanently attached to the flexible signal carrier. These connector elements can be for example:
snap fasteners, rivets or other textile fixtures;
conductive Velcro®
magnetic strips or components.

If the bridging component is a magnet, it is only necessary to move it into the active field range of the reed switch in order to open or close the circuit. It is therefore not necessary for it to make contact with the connector elements.

3. An ‘electronic controller module’ is a housed circuit, which attaches to the opposite end of the flexible signal carrier. The electronic controller module contains an electronic processor, such as a microprocessor capable of detecting the when the bridging component is removed from the flexible signal carrier and then activating either an audible or visual alarm. The electronic controller module may have integrated connector elements so it may be easily attached and detached from the flexible signal carrier in order to allow for removal or washing of the article.

These connector elements can be realised using several methods, for example:
attaching textile based connectors to the ends of the flexible signal carrier such as snaps, rivets or other textile fixtures;
attaching crimp contacts to the ends of the electrodes using a tool (such as those used in the FPC/Flexible printed circuit industry). These crimp contacts may then be connected to an industry standard mating connector.

The electronic controller module may also be attached to the flexible signal carrier using for example, conventional electronic connectors such as I/O pin connectors, jack/socket connectors, USB style connectors.

The above-described alarm system may be used for creating an alarmed pocket or enclosure by the following by method, for example:

The bridging component is attached to the flexible signal carrier causing the circuit to be in a closed state. The electronic controller module detects this state (circuit state 1). When the bridging component is detached the circuit is in an open state (circuit state 2) and an alarm is activated. The alarm may be de-activated by, for example, replacing the bridging component. A microcontroller forming part of the electronic controller module allows for various timing functions and states to be employed. For example the alarm may activate only after a timed pause. The alarm may be deactivated after replacing the bridging component for a timed period or any sequence of timed periods. The electronic controller module does not need an on/off switch as the alarm system may be activated and deactivated by touching the bridging component on the connection elements in a specific sequence.

A key part of this invention is the construction of the alarm system. The use of flexible and textile materials allows the alarm system to be incorporated into garments or soft bag products by means of sewing, bonding or other assembly methods commonly used in the garment construction industry. The ability for the alarm system to be fully incorporated within the finished product means that it can be hidden from the user and will not interfere with the function, aesthetics or comfort of the finished product.

Advantages of the alarm system over existing technologies include:
The devices embodied in this invention can be manufactured very economically because of the small number of simple parts.
Since all these parts are flexible or soft in nature this system can be used as security device in a large number of applications for example but not limited to: bags, luggage, wearable electronics, garments, handbags, pockets.

Referring to FIG. 1, this diagram shows a top view of a first embodiment of a complete alarm system. The flexible signal carrier 1 here is a woven textile tape with conductive yarns 2. The conductive yarns act as electrodes 2 in the system and in this example are in pairs. At one end of the woven textile tape 1 there are two female snap fasteners 3 acting as connector elements 3 that are fixed to the tape, providing permanent electrical contact with the electrodes 2. Corresponding mating male snap fasteners are embedded in a bridging component 5. The bridging component 5 is a metal plate with an attachment loop 6 for attaching the bridging component to a zip or other fixture. At the other end of the flexible signal carrier 1 snap fasteners 3 are connected to the conductive yarn electrodes 2 and are used as connector elements for attaching an electronic controller module 4.

The electronic controller module 4 contains a microprocessor, powered by a battery (not shown), capable of detecting the when the bridging component 5 is removed from the flexible signal carrier 1 and then activating either an audible or visual alarm (or both). The electronic controller module 4 may have integrated connector elements 3 so that it may be easily attached and detached from the flexible signal carrier to allow for removal or washing.

FIG. 2 shows the alarm system according to the first embodiment in which both the bridging component 5 and the electronic controller module 4 are attached to the flexible signal carrier 1. The bridging component 5 creates a closed electrical circuit between the electrodes 2 on both sides of the flexible signal carrier 1. The electronic controller module 4 is also attached to the electrodes 2 with snap fasteners 3 and can detect whether the bridging component 5 is attached or detached.

FIG. 3 shows a side view of the system described for FIGS. 1 and 2. It can be seen that the snap fastener connector elements 3 make permanent electrical contact with the electrodes 2 within the flexible signal carrier 1. The electronic controller module 4 and the bridging component 5 are attached to the connector elements 3 by pressing downwards.

FIG. 4 shows a side view of the system described for FIGS. 1 and 2 with both the electronic controller module 4 and the bridging component 5 attached to the flexible signal carrier 1. The bridging component 5 can be detached easily by pulling it upwards and hence breaking the electrical contact between the pair of electrodes 2.

FIG. 5 shows a schematic circuit diagram of the system according to the first embodiment where the bridging component 5 is detached. This is an open circuit.

FIG. 6 shows a schematic circuit diagram of the system according to the first embodiment where the bridging component 5 is attached. This is a closed circuit.

FIG. 7 shows a schematic circuit diagram of a typical control circuit used for alarm control and activation in the electronic controller module 4. In this example a buzzer is used for an audible alarm.

FIG. 8 shows an example of the alarm system incorporated into a backpack 7. The backpack 7 has a zipped pocket 8 on the front. A bridging component 5 containing snap fastener connector elements 3, is attached to the zip puller 12 with a short braided cord 13. When the zipper is closed, and the bridging component 5 is attached to the snap fastener connector elements 3, the system is in armed (in other words a closed circuit is formed). The flexible signal carrier 1 and electronic controller module 4 are integrated inside the bag pocket.

FIG. 9 shows the example in FIG. 8 where the bridging component 5 is detached, causing the electronic controller module 4 to activate a beeper alarm. In this example the alarm is sounded after the bridging component 5 has been detached from the snap fastener connector elements 3 for more than 2 seconds. In this example the alarm can be deactivated by either re-attaching the bridging component 5 or by attaching and detaching the bridging component twice within 2 seconds. This sequence is detected by the microprocessor in the electronic controller module 4. Therefore, the zipped pocket is armed when closed, and when an unauthorised person opens the zip, the alarm will sound.

FIG. 10 shows an example of the alarm system incorporated in a garment 9. The garment is a pair of trousers 9 with a rear pocket 10 and a closing flap on the pocket. The flap has an integrated bridging component 5 containing snap fastener connector elements 3. A flexible signal carrier 1 is integrated into the main part of the pocket fabric and an electronic controller module 4 is attached to the other end of the flexible signal carrier 1 inside the pocket. The figure shows the flap in a closed position and the bridging component 5 snaps attached to the mating snap fasteners on the flexible signal carrier 1.

FIG. 11 shows the system shown in FIG. 10, with the pocket flap in an open position. The bridging component 5 is detached from the snap fastener connector elements 3 on the flexible signal carrier 1, causing the electronic controller module 4 alarm to sound.

FIG. 12 shows an example of the alarm system incorporated into a handbag 11. The handbag 11 has a zipped opening 8. A bridging component 5, containing snap fastener connector elements 3, is attached to the zip puller 12 with a short braided cord 13. A flexible signal carrier 1 is integrated into the handbag construction and an electronic controller module 4 is attached to the other end of the flexible signal carrier 1 inside the handbag 11. The figure shows the zip in a closed position and the bridging component 5 attached to the mating snap fasteners on the flexible signal carrier 1.

FIG. 13 shows the system shown in FIG. 12, with the zip in an open position. The bridging component 5 is detached from the snap fastener connector elements 3 on the flexible signal carrier 1, causing the electronic controller module 4 alarm to sound.

FIG. 14 shows a top view of a second embodiment of the alarm system. The flexible signal carrier 1 here is a woven textile tape with conductive yarns 2. The conductive yarns act as the electrodes 2 in the system and in this example are in pairs. At one end of the woven textile tape 1 two female snap fasteners 3 acting as connector elements 3 are fixed to the tape providing permanent electrical contact with the electrodes 2. Another connector element is attached which is a reed switch 15 component bridging the two electrodes. The reed switch is soldered onto the connector elements.

A magnet component 14 is embedded in a bridging component 5. The bridging component 5 is a metal plate with an attachment loop 6 for attaching the bridging component to a zip or other fixture.

At the other end of the flexible signal carrier 1 snap fasteners 3 are used as connector elements for attaching the electronic controller module 4 and provide permanent electrical contact with the conductive yarn electrodes 2.

FIG. 15 shows the system illustrated in FIG. 14 where the bridging component 5 is moved directly over (but not necessarily in contact with) the reed switch component. The electronic controller module 4 is attached to the flexible signal carrier 1. Due the magnetic field acting on the reed switch, the bridging component 5 creates a closed electrical circuit between the electrodes 2 on both sides of the flexible signal carrier 1. The electronic controller module 4 is also attached to the electrodes 2 with snap fasteners 3 and can detect when the bridging component 5 is either in proximity or not in proximity of the reed switch 15.

FIG. 16 shows a side view of the system illustrated in FIGS. 14 and 15 with the electronic controller module 4 attached to the flexible signal carrier 1. The bridging component 5 containing the magnetic component 14 is in proximity to the reed switch 15 causing a closed circuit. This diagram also shows the reed switch component encapsulated in a polymer material 16 to create a durable case for the component.

With reference to FIG. 17, the bridging component 5 can be moved upwards and out of proximity of the reed switch 15, hence breaking the electrical contact between the pair of electrodes 2. i.e. an open circuit is formed.

Thus, embodiments of the invention aim to provide at least some of the following benefits:
An alarm system suitable for installation into soft products whereby an alarm is raised when there is unauthorised entry or opening of a pocket or enclosure.
In some of the main components of the system can be textile in nature making them suitable for integration into textile products.
The alarm may be easily deactivated by the user because of a predetermined microcontroller timed sequence of opening and closing the alarm circuit
The system is designed for economical mass manufacture.

1. A security apparatus for a substantially man-made or natural textile, leather or fabric article comprising a closure moveable between an open and closed configuration, the apparatus comprising:
at least one electrically conductive element located on or in the article;
a source of electrical power; and
an electrically operated alarm;
wherein the alarm is arranged to be activated when the closure moves from one of the open and closed configurations to the other configuration.

2. An apparatus according to claim 1, further including circuit making/breaking apparatus arranged such that when the closure moves from one of the open and closed configurations to the other configuration the bridging component moves, causing an electrical circuit to be made or broken.

3. An apparatus according to claim 1, wherein the electrically conductive element is a flexible electrical conductor.

4. An apparatus according to claim 2, wherein the electrically conductive element is a flexible electrical conductor.

5. An apparatus according to claim 1, wherein the electrically conductive element is a textile structure.

6. An apparatus according to claim 1, further including an electronic controller comprising a processor arranged to control the alarm in response to movement of the closure from one of the open and closed configurations to the other configuration.

7. An apparatus according to claim 1, wherein in the closed configuration the closure is arranged to make physical and electrical connection with a portion of the article

8. An apparatus according to claim 7, wherein the physical and electrical connection is made through one or more connector elements.

9. An apparatus according to claim 8, wherein the or each connector element comprises one or more of: snap fasteners, rivets, conductive Velcro®, magnetic strips or components or other textile fixtures

10. An apparatus according to claim 2, wherein the circuit making/breaking apparatus comprises a magnet and reed switch, one of which is located on the closure and the other of which is located on another portion of the article.

11. A substantially man-made or natural textile, leather or fabric article comprising a closure moveable between an open and closed configuration including a security apparatus according claim 1.

12. A substantially man-made or natural textile, leather or fabric article comprising a closure moveable between an open and closed configuration including a security apparatus according claim 2.

13. A substantially man-made or natural textile, leather or fabric article comprising a closure moveable between an open and closed configuration including a security apparatus according claim 5.

14. A substantially man-made or natural textile, leather or fabric article comprising a closure moveable between an open and closed configuration including a security apparatus according claim 6.

15. A substantially man-made or natural textile, leather or fabric article comprising a closure moveable between an open and closed configuration including a security apparatus according claim 10.

16. Apparatus substantially as described herein with reference to the attached drawings.
